(19) United States
(12) Patent Application Publication
(10) Pub. No.: US 2005/0254339 A1
(43) Pub. Date: Nov. 17, 2005

(54) Method and apparatus for mixing and dispensing construction materials

(76) Inventor: Lee Ferguson, Carlsbad, CA (US)

Correspondence Address: John A. Mizhir, Jr.;Mizhir & Associates, Suite 301, 462 Stevens Avenue, Solana Beach, CA, 92075, US

(21) Appl. No.: 11/128,827

(22) Filed: May 14, 2005

Related U.S. Application Data
(60) Provisional application No. 60/571,354, filed on May 14, 2004.

(51) Int. Cl. B01F 13/00

(52) U.S. Cl. 366/129

(57) ABSTRACT

An apparatus for mixing and dispensing construction materials configured as flexible sheet. The sheet may be shaped generally like a square, triangle, circle rectangle, or other suitable shape, and may range in size between approximately 36 inches square and 96 inches square and may have a thickness between approximately four and ten millimeters. The sheet may be made materials that exhibit draping or hand characteristics, a high tensile strength, puncture and abrasion resistance, and a high friction co-efficient. The sheet may also comprise grasping mechanisms. A method for mixing ingredients and thereafter dispensing the end materials by placing one or more ingredients to be mixed on the sheet, forming an interior vessel by upwardly lifting one or more edges of the sheet, lifting and lowering one or more edges of the sheet to mix the ingredients to make an end material, and forming an interior flexible chute in the sheet by lowering one or more edges of the sheet and raising one or more other edges of the sheet to facilitate dispensing the end material into a desired location.

### CROSS-REFERENCE TO RELATED APPLICATIONS

The present application claims priority to U.S. Provisional Patent Application Ser. No. 60/571,354 entitled “METHOD AND APPARATUS FOR MIXING AND DISPENSING by Lee Ferguson, filed May 14, 2004, the entirety of which is hereby specifically incorporated by reference for all it discloses and teaches.

### STATEMENT AS TO RIGHT TO INVENTIONS MADE UNDER FEDERAL SPONSORED RESEARCH AND DEVELOPMENT

None

### FIELD OF THE INVENTION

The following description relates to methods and apparatus for mixing and dispensing dry or liquid materials or a combination thereof, and particularly to methods and apparatus for mixing and dispensing relatively small amounts of construction materials, such as concrete, stucco, and mortar.

### DESCRIPTION OF BACKGROUND

Several types of end materials essential in construction, such as concrete, stucco, and mortar, are created by mixing dry and liquid starting or base ingredients. Devices for mixing such ingredients and then depositing the end materials can be found on any construction site and are generally designed like an opened ended drum that rotates to mix and agitate the base materials. These devices range in size, but even the smallest ones must generally be transported by truck or large vehicle. Their size can also make them difficult to negotiate around the many obstacles inherent at a construction site and also require substantial storage space when not in use. Moreover, their size and awkward shape can cause inaccurate dispensing of the end materials into the desired location. Also, because conventional devices mix the ingredients in a generally enclosed drum, cleaning its interior is difficult, and stray end material may remain even after thorough washing.

### SUMMARY OF THE INVENTION

The apparatus and methods herein disclosed for mixing and dispensing construction materials resolve many inconveniences associated with using conventional mixing and dispensing devices, especially when only a relatively small amount of end material is required. Because the apparatus is generally flat in shape and flexible, it can be transported by virtually any means and stored almost anywhere. It has no electrical, mechanical or moving parts, essentially vitiating the possibility of malfunction, and the material of which it is comprised is nearly indestructible. The flexibility and shape of the apparatus also make it simple to thoroughly clean, negotiation around obstacles and accurately dispense the end materials. The method for using the apparatus to mix and dispense end construction materials is simple, yet ingenious, and provides an unparalleled convenient way to mix relatively smaller quantities of ingredients and to thereafter accurately dispense the end materials.

The apparatus for mixing and dispensing may be configured as a flexible sheet. The sheet may be made or derived from any type of material or combination thereof that exhibit draping and/or hand characteristics, a high tensile strength, puncture and abrasion resistance, and a high friction co-efficient.

In the preferred implementation, the sheet is square, having four corner, four sides, and a top and bottom surface with dimensions between approximately 36 inches square to 96 inches square and a thickness between four and ten millimeters. However, in other implementations, the sheet may be triangular, rectangular, circular or curvilinear, or other suitable shape. Moreover, the thickness of the sheet may be uniform or it may vary at different areas of the sheet. Generally, the sheet may include any combination of these dimensions and thicknesses, which will largely depend on the amount and weight of materials to be mixed and dispensed.

In another implementation of the apparatus, the sheet may be configured to include grasping elements. For example, cut-outs in the sheet may be used to securely grasp the sheet. Likewise, handles, ropes, knobs, roughened edges, or other similar grasping elements may be provided in the corners or other areas of the sheet to accomplish this same purpose.

The method of mixing and dispensing that may be used with the apparatus can vary. In the preferred method using the preferred implementation of the apparatus, the corners of the sheet are raised to form a flexible vesicle and then opposite corners of the sheet are sequentially lifted and lowered to mix the ingredients to make the end materials. Two or more corners of the apparatus are then lifted higher than the opposite corners to form an interior flexible chute in the first surface of the sheet, which allows the end material to flow out and to be accurately dispensed in the desired location. Other methods can be employed to accomplish the same results. Moreover, the preferred or other methods can be employed with other implementations of the apparatus to accomplish the same results.

### BRIEF DESCRIPTION OF THE DRAWINGS

FIG. 1 is a flat view of one implementation of the apparatus.

FIG. 2 is a flat view of another implementation of the apparatus.

FIG. 3 shows the positioning of ingredients on the preferred implementation of the apparatus.

FIG. 4 shows one method for forming an interior flexible vessel in the preferred implementation of the apparatus.

FIG. 5 shows one method for forming a flexible chute in the preferred implementation of the apparatus to facilitate dispensing the end materials.

### DETAIL DESCRIPTION OF THE PREFERRED EMBODIMENTS

While the disclosed apparatus and method for mixing and dispensing is susceptible of numerous implementations, there is shown in the drawings and herein described in further detail, exemplary implementations, with the understanding that the present disclosure is to be considered as illustrative of the principles of the apparatus and not intended to limit the invention to the exemplary embodiments shown and described.

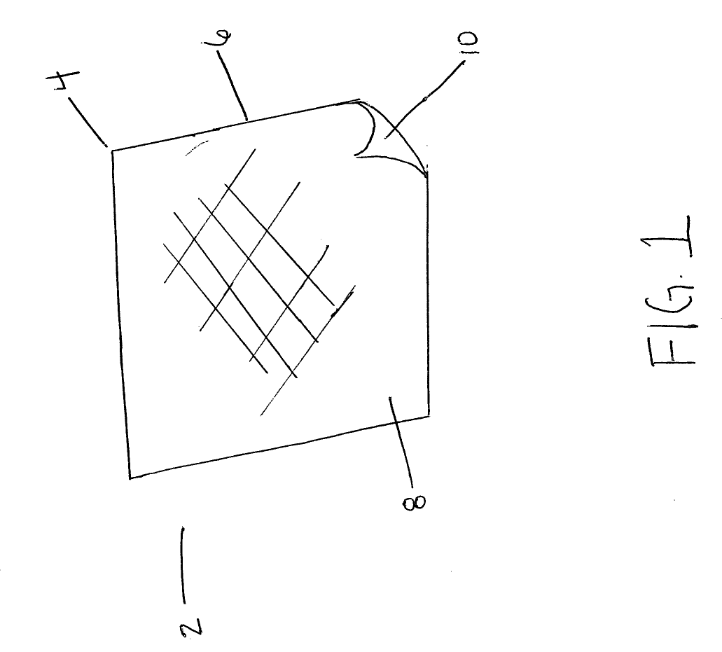

The preferred implementation of the apparatus for mixing and dispensing is generally illustrated in FIG. 1. In this implementation the apparatus is configured as a flexible sheet 2. The sheet 2 may be made or derived from any type of material or combination thereof that exhibits draping or hand characteristics, a high tensile strength, puncture and abrasion resistance, and a high friction co-efficient. For example, the sheet 2 may be made of polyethylene, or similar types of plastic or plastic subsets, such as polypropylene, plytetrafluroethylene, polystyrene, polyvinylchloride, thermosets or resins (epoxy, polyester, phenol-formaldehyde), elastomers or rubbers (polyisoprene, polybutadiene, polychloroprene) and natural polymers, such as ABS, polyurethane, silicon, and, natural rubber.

In the preferred implementation, the sheet 2 is square in shape, having four corners 4, four sides 6, and a first or top surface 8 and a second or bottom surface 10. However, alternate implementations of the apparatus can be triangular, rectangular, circular or curvilinear, or other suitable shape. The dimensions of the sheet 2 can vary between approximately 36 inches square to 96 inches square and a thickness between four and ten millimeters. In this implementation, the apparatus is uniform in thickness; however, other implementations may vary in thickness at different areas of the sheet 2. Generally, the sheet 2 may include any combination of the disclosed dimensions and thicknesses. The dimensions and thickness will largely depend on the amount and weight of materials to be mixed and dispensed.

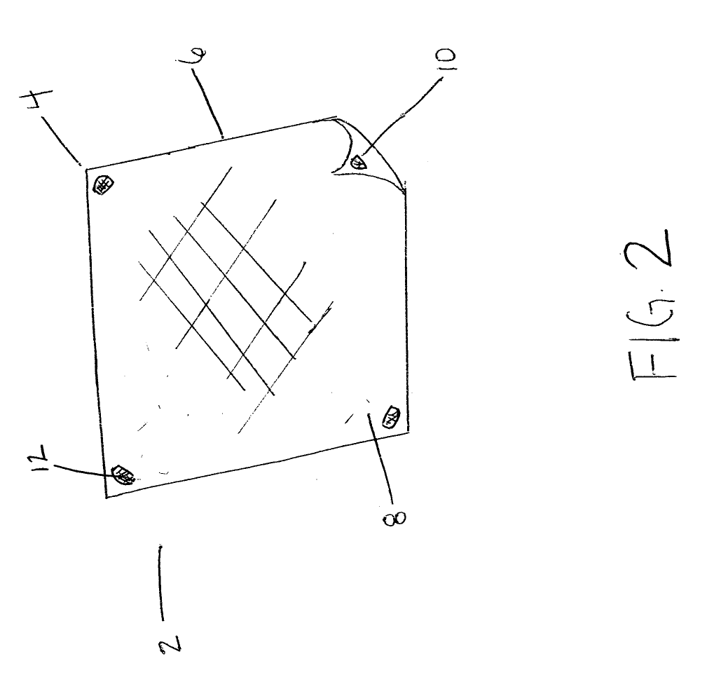

In another implementation of the apparatus, as illustrated in FIG. 2, the sheet 2 may also be configured to include grasping elements 12. For example, cut-outs in the sheet may be used to securely grasp the sheet 2. Likewise, handles, ropes, knobs, roughened edges, or other similar grasping elements 12 may be provided in the sheet's corners 4 or along the sides 6 or other areas to accomplish this same purpose.

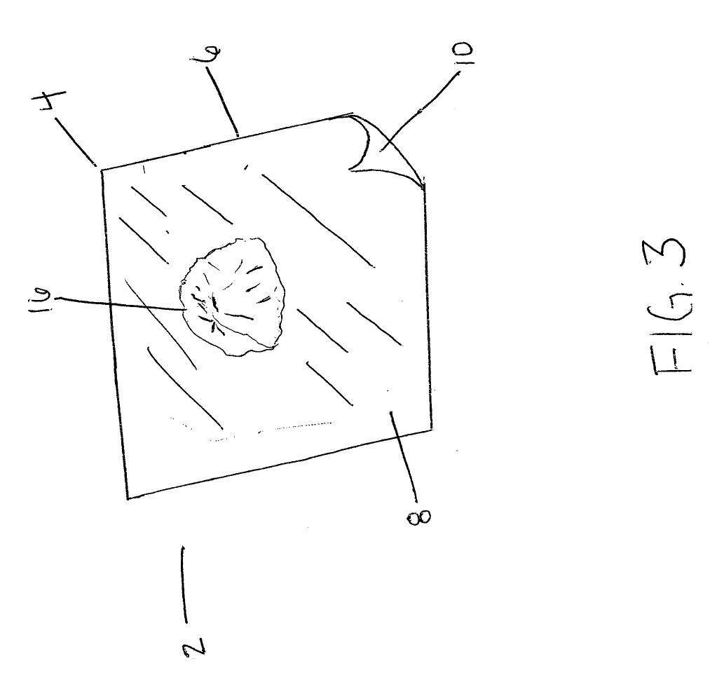

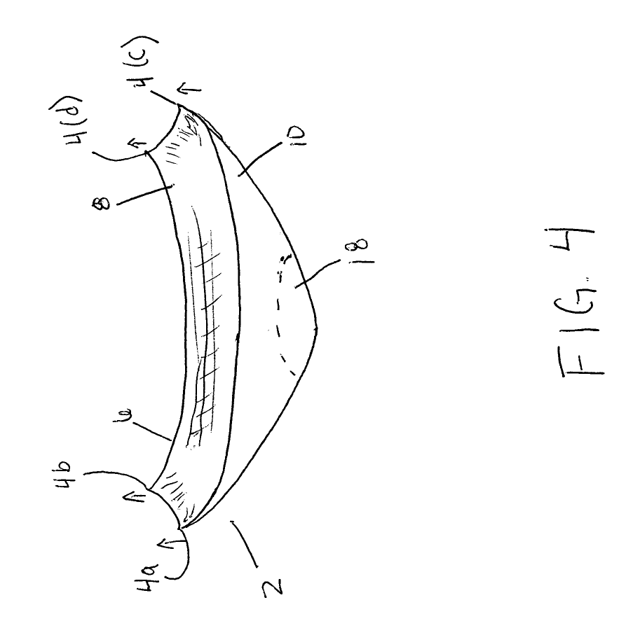

The method of mixing materials that may be used with the preferred implementation is illustrated in FIGS. 3 and 4, while the method for dispensing is illustrated in 5. As seen in FIG. 3, the sheet 2 is positioned so that its first surface 8 faces upwards and its second surface 10 faces downwards. The sheet 2 may be spread out by any suitable means readily known to one of ordinary skill in order to maximize its surface area and thereby facilitating the placement of the materials to be mixed onto the first surface 8. For instance, the sheet 2 may be spread out upon a relatively flat surface, such as the ground, on the back of truck or other similar surface. The sheet 2 can also be spread out by being held taut by one or more persons or devices. Furthermore, the sheet 2 may be spread at a location proximate to where the end materials mixture will be dispensed in order to reduce the distance of moving or carrying the sheet 2 and its contents to the dispensing location.

The ingredients 16 to be mixed may be deposited any where on the first surface 8. FIG. 3 illustrates the ingredients 16 deposited in or around the center of the first surface 8 in order to ensure that the ingredients 16 do not spill off the first surface 8 onto surrounding areas. The ingredients 16 may be dry or liquid, or any combination thereof. The amount of ingredients 16 may vary according to the size of the sheet 2 and weight of the ingredients 16 or end material. If both dry and liquid ingredients 16 are required for the end material, a depression (not shown) may be made in the dry ingredients 16 to hold the liquid. The depression ensures the liquid ingredients 16 remain within the boundaries of the sheet 2. For example, when mixing concrete with the sheet 2, the dry ingredients of concrete, i.e., cement, sand, and aggregate, may be added to the approximate center of the sheet 2 and a depression may be made in the ingredients. The appropriate amount of water or other liquid is then poured into the depression.

Once the ingredients 16 are positioned on the sheet 2, one or more corners 4, edges 6, grasping elements 12 or other area of the sheet 4 is grasped and lifted upwards. As shown by the arrows in FIG. 4, the four corners 4 of the preferred implementation of the apparatus are lifted upwards. This upward lifting forms an interior flexible vessel or receptacle 18 on the first surface 8 of the sheet 2 and holds and contains the ingredients 16. This upward lifting may be accomplished in various ways. For instance, the corners 4 may be grasped and lifted by one or more persons or devices or other similar means. The size of the sheet 2 and the amount of ingredients 16 determine the height at which the corners 4 are lifted. For example, with a larger sheet 2, the corners 4 may be lifted to approximately two and half feet, or to waist high on an average sized adult person. When the corners 4 are lifted, the second surface 10 of the sheet 2 may remain on the ground because of the weight of the ingredients 16 or size of the sheet 2.

The ingredients 16 are then mixed as necessary or desired by repeatedly lifting upwards one or more corners 4, edges 6, grasping elements 12 or other area of the sheet 2 higher than the one or more other corners 4, edges 6, grasping elements 12 or other area of the sheet 2. One or more alternate corners 4 of the sheet 2 is lifted higher than the other corner(s) 4 to mix the ingredients 16. Several different mechanisms may be employed to facilitate this mixing process. For instance, two people could each hold two corners 4 of the sheet 2 waist high. In this instance, one person may hold two adjacent corners 4 of the sheet of FIG. 4, such as corners 4(a) and 4(b), while the other person holds the two remaining adjacent corners, corners 4(c) and 4(d), so that all four corners 4 are being held. The first person commences the mixing process by raising one corner 4(a) of the sheet 2 to chest level. Although any corner 4 can be lifted first, if the first person lifts the corner in his right hand 4(a), then this first action causes the ingredients 16 within the flexible vessel 18 to turn and/or roll right-to-left diagonally toward the opposite corner 4(d) being held by the second person. When this first action is complete, the first person lowers the corner in his right hand 4(a) back to waist height, while the second person commences the second action by lifting the corner in his right hand 4(d) to chest level, causing the mix to turn and/or roll back right-to-left diagonally toward opposite corner 4 (a) being held by the first person. When the second action is complete, the second person lowers the corner 4(d) in his right hand back to waist height, while the first person commences the third action by lifting the corner in his left hand 4(b) to chest level. This causes the mix not only to turn and/or roll left-to-right diagonally toward the opposite corner 4(c) being held by the second person, but it also causes the ingredients to turn and/or roll at approximately 90 degrees to the first action. When the third action is complete, the first person lowers the corner 4(b) in his left hand to waist height, while the second person commences the fourth action by lifting the corner in his left hand 4(c) to chest level. This causes the mix not only to turn and/or roll left-to-right diagonally toward the opposite corner 4(b) being held by the first person, but it also causes the mix to turn and/or roll at approximately 90 degrees to the third action. When the fourth action is complete, the first mix cycle is finished. Mix cycles are repeated until the ingredients are mixed as necessary or desired. When employing repeated mix cycles, any action (i.e., first, second, third, or fourth) of the second and subsequent mix cycles will obviously cause the ingredients to both turn and/or roll diagonally and at approximately a 90 degree angle to the corresponding previous action of one or more cycles.

Although the mixing method described above employs sequentially lifting and lowering opposite corners, the mixing method can be accomplished by varying such sequentially lifting and lowering. For example, lifting 4(a) and lowering 4(d) and lifting 4(d) and lifting 4(a) could be done repeatedly to accomplish a first action. It is important then, to realize that exact sequential method of lifting and lowering the corners 4 is not limited and that variations can be employed to attain the same results of mixing the ingredients 16.

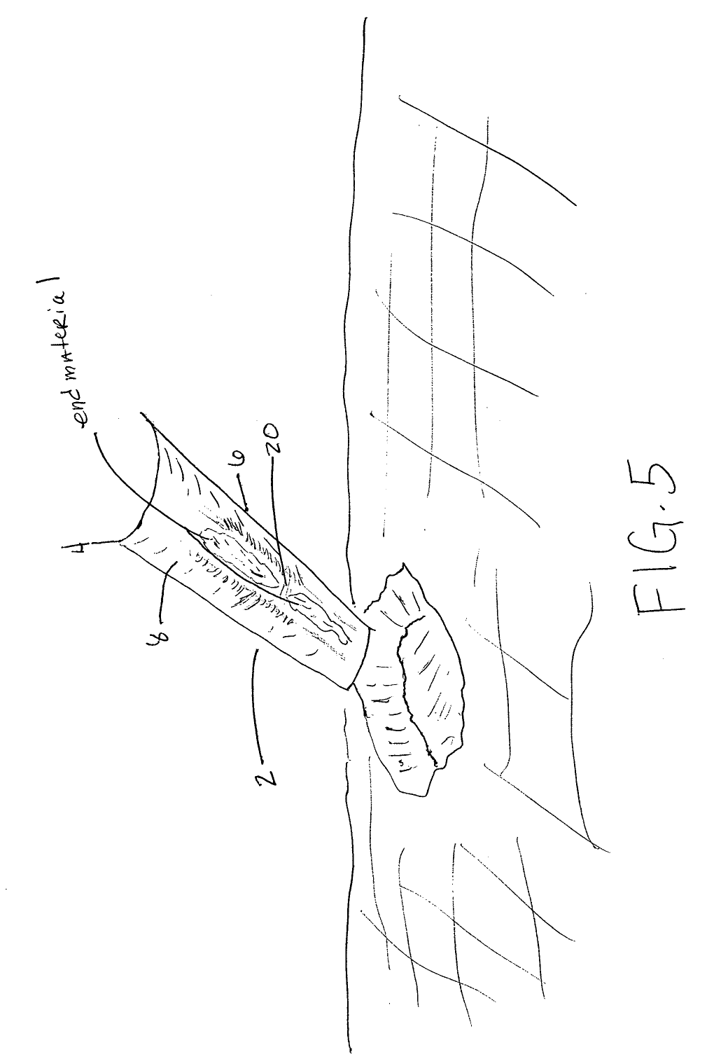

When the mixing action is completed as necessary or desired, the end material is typically ready to be dispensed. If using the preferred implementation of the apparatus, during the dispensing process, the corners 4 of the sheet 2 may be maintained at a height sufficient to retain the form of the flexible vessel 18, ensuring the end materials do not inadvertently leak or spill off the sheet 2. The corners 4 of the sheet 2 may be raised simultaneously or nearly simultaneously further upwards, lifting the sheet 4 and its contents off the ground or surface on which it sits, if any. The sheet 2 and its contents may then be moved to the location where the mixture is to be dispensed. If the contents of the sheet 2 are too heavy to be lifted off the ground, the sheet 2 may be dragged to the dispensing location by grasping one or more corners 4 of the sheet 2. Regardless of how the sheet 2 is moved, once at the dispensing location (as shown by FIG. 5) the corner or corners 4 of the sheet closest to the dispensing location may be lowered, while the opposite corner or corners 4 are raised, forming an interior flexible chute 20 in first surface 8 of the sheet 2, which allows the end material to flow out and to be dispensed in the desired location 22.

The apparatus and methods described above provide for a quick and efficient means for mixing relatively small amount of materials, such as construction materials, including concrete, stucco, and mortar, without the need for large mixing apparatuses or devices generally required for accomplishing such mixing and dispensing. Moreover, the apparatus and methods described above allow for easy movement of the end materials to the dispensing location, as well as for easy and accurate dispensing of the end materials.

A number of implementations have been described. Other implementations may include different or additional features. For example, if the apparatus is circular or some other shape not having corners, the same mixing method can still be used except that rather than grasping and lifting the sheets corners, other areas or edges on the sheet will be grasped and lifted that allow for forming and maintaining the interior receptacle, mixing the ingredients by lifting alternate areas of the sheet, and for forming an interior flexible chute for dispensing the mixture. Similarly, one or more grasping elements can be incorporated into any variation of the sheet. The one or more grasping elements may include any type known to one of skill in the art, such as cut-outs, handles, ropes, knobs, roughened edges, or other similar grasping elements.

1. An apparatus for mixing and dispensing materials comprising the following:
a generally flat sheet;
said sheet being comprised of materials exhibiting draping or hand characteristics, a high tensile strength, puncture and abrasion resistance, and a high friction coefficient; and
said sheet ranging in size between approximately 36 inches square to 96 inches square and having a thickness between approximately four and ten millimeters.

2. The apparatus of claim 1 further comprising one or more grasping mechanisms.

3. The apparatus of claim 1 further being generally shaped like a square, triangular, rectangular, circular or curvilinear.

4. A method for mixing and dispensing materials comprising:
placing one or more ingredients to be mixed on a generally flat sheet being comprised of materials exhibiting draping or hand characteristics, a high tensile strength, puncture and abrasion resistance, and a high friction co-efficient and ranging in size between approximately 36 inches square and 96 inches square and having a thickness between approximately four and ten millimeters;
forming an interior vessel in the sheet by upwardly lifting one or more edges of the sheet;
lifting and lowering one or more edges of the sheet to mix the ingredients as necessary to form an end material;
forming an interior flexible chute in the sheet by lowering one or more edges of the sheet and raising one or more other edges of the sheet to facilitate dispensing the end material into a desired location.
